(19) United States
(12) Patent Application Publication
(10) Pub. No.: US 2011/0090042 A1
(43) Pub. Date: Apr. 21, 2011

(54) WIRELESS DEMAND RESPONSE SYSTEM

(75) Inventors: Thomas W. Leonard, Tualatin, OR (US); Richard A. Leinen, Wilsonville, OR (US); Robert L. Hick, Newberg, OR (US)

(73) Assignee: Leviton Manufacturing Co., Inc., Melville, NY (US)

(21) Appl. No.: 12/603,436

(22) Filed: Oct. 21, 2009

(51) Int. Cl. G05B 19/00

(52) U.S. Cl. 340/5.1

(57) ABSTRACT

A wireless demand response endpoint includes a power switch and a wireless receiver to control the power switch in response to a wireless demand signal. The wireless demand signal may be transmitted at the same premises as the endpoint. One or more wireless endpoints at the premises may be configured to respond to the wireless demand signal. The wireless demand signal may be transmitted automatically, manually, or in other modes. Power switching may be on/off, dimming, etc.

### BACKGROUND

The amount of electric power demanded from a power plant or utility grid varies depending on the time of day, local weather patterns, failure of other power plants on the grid, and other factors that may be difficult to predict. Overloading during periods of peak demand may cause failure of the power plant or grid, under voltage events (brownouts), or may force the utility to activate reserve generating capacity which is typically expensive to operate.

A demand response system enables a utility to improve the reliability of a power plant or grid and/or reduce operating costs by instructing customers to reduce their demand during periods of peak demand. In a demand response system, the utility provider contacts one or more customers when it becomes apparent that the peak load will exceed the capacity of a power plant or grid, or when power will be relatively expensive to generate. The customers may respond by switching to alternative power sources such as local generation (cogeneration), reducing their power consumption (load shedding), or a combination of both. The utility typically sends a demand response request to the customers' premises in the form of a digital message through a radio transmission, internet connection, or other medium.

### BRIEF DESCRIPTION OF THE DRAWINGS

FIG. 1 illustrates an embodiment of a wireless demand response endpoint according to some inventive principles of this patent disclosure.

FIG. 2 illustrates an embodiment of a wireless demand response system according to some inventive principles of this patent disclosure.

FIG. 3 illustrates another embodiment of a wireless demand response system according to some inventive principles of this patent disclosure.

FIG. 4 illustrates another embodiment of a wireless demand response endpoint according to some inventive principles of this patent disclosure.

FIG. 5 illustrates an embodiment of a method for configuring and operating a wireless demand response system according to some inventive principles of this patent disclosure.

FIG. 6 illustrates an embodiment of a wireless demand response installation according to some inventive principles of this patent disclosure.

FIG. 7 illustrates an embodiment of a power strip for a wireless demand response system according to some inventive principles of this patent disclosure.

FIG. 8 illustrates an embodiment of a lamp adapter for a wireless demand response system according to some inventive principles of this patent disclosure.

FIG. 9 illustrates an embodiment of an in-line power module for a wireless demand response system according to some inventive principles of this patent disclosure.

FIG. 10 illustrates an embodiment of an appliance for a wireless demand response system according to some inventive principles of this patent disclosure.

FIG. 11 illustrates an embodiment of an outlet for a wireless demand response system according to some inventive principles of this patent disclosure.

FIG. 12 illustrates an embodiment of a power pack for a demand response sensing system according to some inventive principles of this patent disclosure.

### DETAILED DESCRIPTION

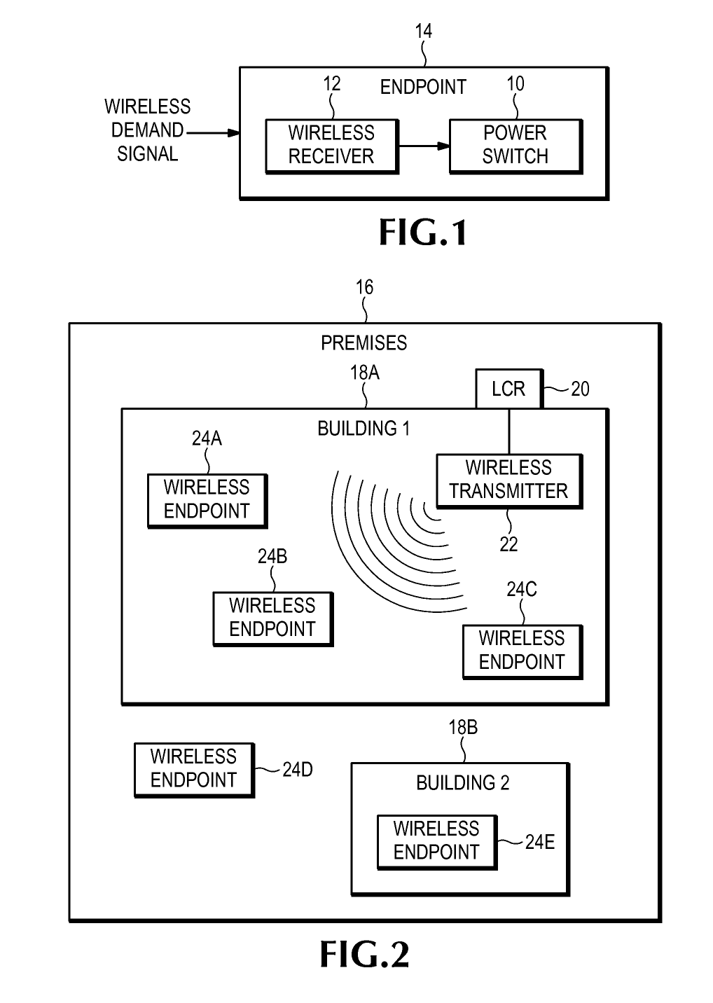

FIG. 1 illustrates an embodiment of a wireless demand response endpoint according to some inventive principles of this patent disclosure. A power switch 10 and wireless receiver 12 are located at an endpoint 14 of an electrical power system. An endpoint may be anywhere on a branch circuit, for example, at a light fixture, an exhaust or ceiling fan, a wall switch, a receptacle, a relay cabinet, a power pack, a hard-wired appliance, a cord-and-plug connected appliance, etc. The power switch 10 may be implemented with mechanical or solid state relays, transistors, thyristors, or any other suitable technology to control the flow of power to any number of loads. The power switch 10 may provide on/off control, variable levels of power control in continuous or discrete steps such as dimming control of lights or variable speed control of motors, or any other suitable form of power control. On/off and other types of control may provide two-way switching, three-way switching, etc., for a common load or loads from multiple locations.

The wireless receiver 12 controls the power switch 10 in response to a wireless demand signal received at the endpoint 14. Any suitable wireless technology may be used for the wireless demand signal such as radio frequency (RF), infrared (IR), ultrasound (U/S), etc. For example, in a system using RF communication, any custom or standardized communication protocol such as ZigBee, EnOcean, etc. may be used.

The power switch 10 and wireless receiver 12 may be integrated into a single device or included in separate devices. In one example embodiment, the power switch and wireless receiver may be included in a wiring device that can occupy a single gang in a standard electrical box. In another example embodiment, the power switch and wireless receiver may be in separate devices mounted in two different gangs of an electrical box. In yet another embodiment, the power switch may be housed in a relay module which is mounted in a metal relay cabinet located in a utility closet. Since the cabinet and/or closet location may interfere with the wireless demand signal, the wireless receiver may be housed in a plastic case that is attached to the relay cabinet through a conduit fitting, or alternatively, connected to the relay cabinet through a short cable that enables the wireless receiver to be installed anywhere inside or outside the closet.

FIG. 2 illustrates an embodiment of a wireless demand response system according to some inventive principles of this patent disclosure. A premises 16 includes one or more buildings 18A-18B. A load control receiver (LCR) 20 receives a demand signal from a utility, a power plant, a power grid operator, or other power entity outside the premises in a wired or wireless form. A wireless transmitter 22 transmits a local demand signal to one or more wireless demand response endpoints 24A-24E which may be located throughout the premises including inside and outside the buildings. The local demand signal may be a rebroadcast of the demand signal received from outside the premises, or additional processing may be provided, with or without human intervention, to change the format of the signal, provide additional features, remove unwanted features, translate between transmission media and/or protocols, provide judgment or logic as to how load shedding should be implemented in response to the demand signal, etc. Alternatively, the wireless transmitter 22 may transmit the local demand signal to one or more of the endpoints in response to, and at the initiative of, a building administrator. As a further alternative, one or more of the wireless endpoints may respond directly to a wireless demand signal from outside the premises.

As with the wireless receiver 12 shown in FIG. 1, the wireless transmitter 22 of FIG. 2 may use any suitable transmission technology, protocol, etc. Any number and/or type of wireless transmitters 22 may be used. The LCR 20 and wireless transmitter 22 may be integrated in a single device or realized as separate devices. The wireless demand response endpoints 24A-24E may be implemented using any of the inventive principles of this patent disclosure. In the context of an endpoint, the term wireless refers to the ability to receive and/or transmit wireless communications. A wireless endpoint typically switches power through hardwired connections.

Each wireless transmitter 22 may be connected directly to the LCR 20, connected to a building automation network an/or control station to which the LCR is attached, connected to a specialized network for demand response transmitters, or arranged in any other suitable configuration.

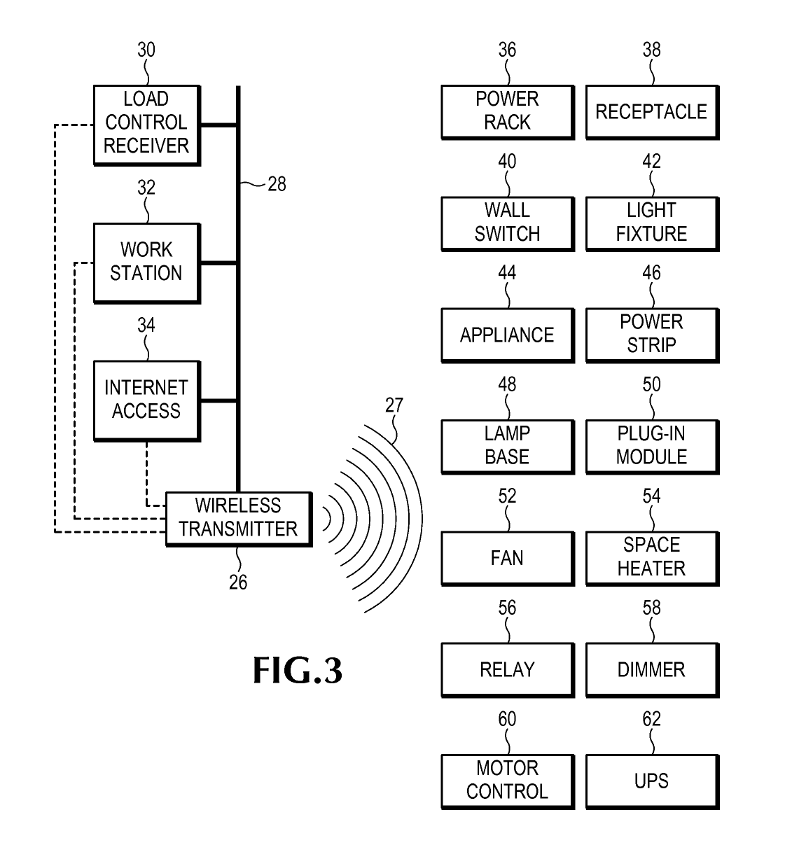

FIG. 3 illustrates another embodiment of a wireless demand response system according to some inventive principles of this patent disclosure. A wireless transmitter 26 is connected to a wired or wireless communication network 28 which may be implemented as a general purpose network such as Ethernet, Wi-Fi, Wi-Max, etc., a specialized control network such as a Control Area Network (CAN), LonWorks, Modbus, etc., or any other suitable network. A load control receiver 30 is attached to the network and receives a demand signal from a utility. A workstation 32 for a building administrator is also connected to the network to facilitate the configuration and/or control the system. The workstation may also be used to implement and/or control other building automation and energy management functionality such as security, heating ventilation and air conditioning (HVAC), lighting controls, etc., that may be connected to the network or workstation. A network access point 34 such as a modem, router, switch, hub, etc., may provide any of the network components with access to the Internet, a local area network (LAN), a wide area network (WAN) or other network.

In some embodiments, the wireless transmitter 26 may be connected directly to the LCR 30, workstation 32 or access point 34 in addition to, or instead of, being connected to the network 28. In some embodiments the LCR, workstation and/or access point may be omitted along with their functions. Alternatively, any or all of the functions of the LCR, workstation and/or access point may be integrated into the same devices as the wireless transmitter 26. A user interface to enable a user to configure and/or operate the system may be included at any or all of the components. The wireless transmitter may be implemented with a wireless gateway, modem, router, switch, hub, etc.

The wireless transmitter 26 transmits a wireless demand signal 27 to any number of wireless demand response endpoint devices. Some examples include a power pack 36, receptacle 38, wall switch 40, light fixture 42, hard-wired or cord-and-plug connected appliance 44, power strip 46, screw-in or plug-in lamp base 48, plug-in switching module 50, ceiling, exhaust or ventilation fan 52, space heater 54, relay 56, dimmer 58, motor speed control 60, uninterruptable power supply (UPS) 62, etc.

The wireless transmitter 26 transmits the wireless demand signal in response to information received from the utility at the LCR 30, and/or in response to the actions of a building administrator or other person. There are a multitude of different methods and configurations in which the system can function according to the inventive principles of this patent disclosure. Some examples are described above and below, but other methods and configurations may be realized without departing from the inventive principles. For example, a transmission from the wireless transmitter 26 may be initiated by the reception of a demand signal from a utility through the LCR, either automatically, or with intervention by a building administrator. Alternatively, the building administrator may initiate the transmission of a demand signal. As a further alternative, the transmission of a demand signal may be initiated by a utility, monitoring service, remote building administrator, etc., through a connection on the internet access point 34. Some further examples of operational and configurational flexibility include methods in which wireless endpoints may be addressed, and methods in which the endpoints may be configured to respond to demand signals as described below.

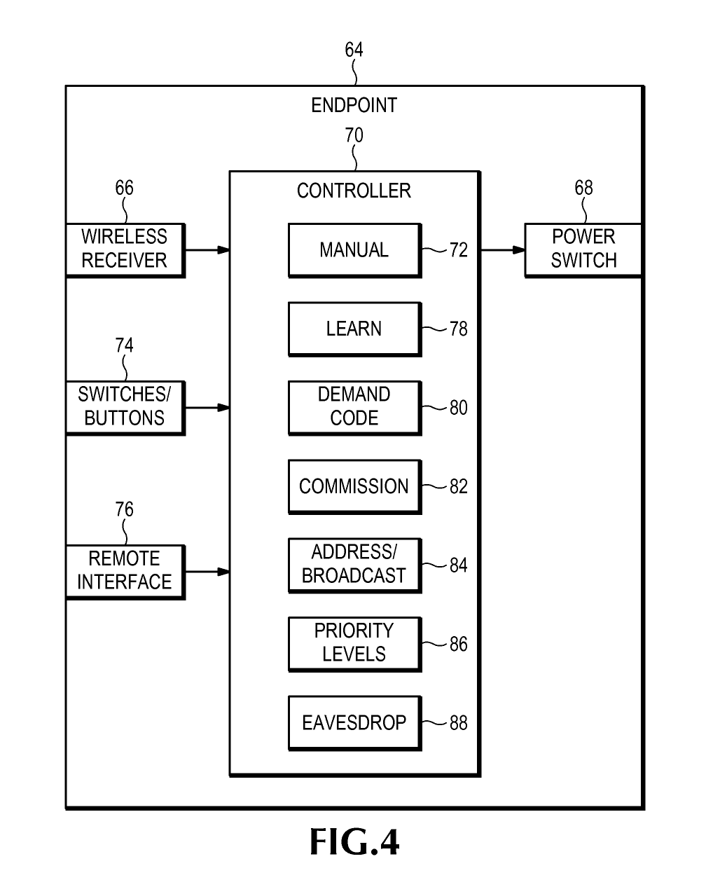

FIG. 4 illustrates another embodiment of a wireless demand response endpoint according to some inventive principles of this patent disclosure. The endpoint 64, which may be implemented as one or more devices, includes one or more wireless receivers 66, one or more power switches 68 and a controller 70 to control the operation of the endpoint.

The controller may include manual configuration functionality 72 to enable an installer to manually program the endpoint to respond to wireless signals from, e.g., a wireless occupancy sensor, a self-powered wireless wall switch transmitter (on/off or dimming), a wireless photocell, and/or a wireless demand response transmitter. Such programming may be accomplished through dip switches or buttons 74, a plug-in or wireless handheld remote interface 76, or any other suitable technique.

The controller may also include learning functionality 78 to enable the endpoint to bind with other wireless devices. For example, an installer may press a certain sequence of buttons to place the endpoint in a learn mode. The installer then causes each wireless device to which the endpoint must respond to transmit a learning pattern to the endpoint, thus enabling the endpoint to bind with each device, including a wireless demand response transmitter. The installer then presses another sequence of buttons to remove the endpoint from learn mode.

The controller may also include functionality 80 to enable the endpoint to respond to a dedicated demand response code or address that is loaded into the endpoint when manufactured or programmed into the endpoint by a distributor, installer, building administrator, etc. When the endpoint receives a transmission with this code, it invokes the appropriate demand response behavior.

The controller may also include commissioning functionality 82 which enables the endpoint to be configured completely or in part by commissioning transmissions from the wireless demand response transmitter and/or a special commissioning transmitter. This functionality may be similar to the manual configuration functionality, but no manual actuation is involved. Instead, the configuration information may be provided through the wireless receiver.

Address/broadcast functionality 84 may be included to enable the endpoint to respond differently to different transmissions. For example, transmissions from certain sources may be treated as broadcast transmissions that all endpoints respond to, whereas transmissions from other sources may be treated as addressed transmissions that the endpoint only responds to if the transmission is addressed specifically to the endpoint or group of endpoints.

Priority functionality 86 may be included to enable the endpoint to respond differently to transmissions having different priority levels. For example, low priority transmissions may be ignored or queued for later response, medium priority transmissions may be responded to if not overridden by transmissions with a higher priority level, and high priority transmissions may always be responded to.

The controller may also include eavesdropping functionality 88 to enable the endpoint to be configured by listening to transmissions between other devices. For example, the endpoint may initially be configured to operate as a manual on/off wall switch with wireless demand response functionality. If the endpoint detects communications between a wireless occupancy sensor and other hardware, the endpoint may configure itself to respond to the wireless occupancy sensor as well. Such self-configuration may be subject to other configuration information for priority levels, addressing, etc.

An endpoint may include any, all or none of the above functionalities. An embodiment having one or more of these functionalities may include inputs or configuration features to enable one or more of the functionalities. For example, an endpoint may include a series of dip switches to select which function or functions to activate.

The embodiment of FIG. 4 is shown with a single wireless receiver, but more than one receiver may be included for responding to different sources of wireless signals. A wireless receiver may also operate at different frequencies, wavelengths, etc. to respond to different transmitters or different messages. For example, wireless occupancy sensors, wireless photocells, wireless demand response transmitters, wireless wall switch transmitters, and wireless handheld remote controls may all be configured to operate at different frequencies, wavelengths, etc. Some other examples include transmitting messages for different priorities, broadcast parameters, device types, etc. at different frequencies, wavelengths, etc. Transmissions for demand response, occupancy sensing, etc., may be formatted for on/off control of power switches, variable level power control (e.g., dimming, variable fan speed), etc.

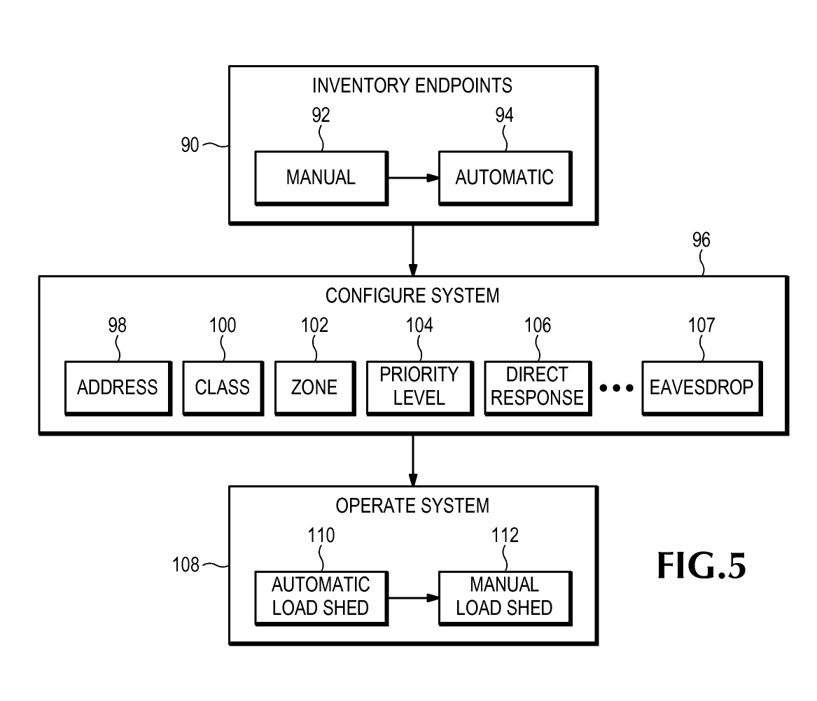

FIG. 5 illustrates an embodiment of a method for configuring and operating a wireless demand response system according to some inventive principles of this patent disclosure. In some embodiments, the method may be implemented in a centralized manner with a program running on a workstation for a building administrator. In other embodiments, the functionality of the method may be integrated into the wireless transmitter and/or distributed throughout multiple components including endpoints, wireless transmitters, workstations, etc. The functionality may be accessed, for example, through a user interface on a workstation, a wireless transmitter, an LCR, etc.

During an inventory process 90, an inventory of the available demand response components is taken. Some or all of the inventory may be taken through a manual process 92 by entering information on the quantities, types, locations, loads, etc. of wireless demand response endpoints, as well as information on the available wireless demand response transmitters, load control receivers (LCRs), etc. Some or all of the inventory may be taken through an automatic or semiautomatic process 94 that uses a wireless demand response transmitter to poll the endpoints. In some embodiments, the endpoints may respond to a poll by temporarily turning their associated loads on or off to identify themselves to a person who can then complete the inventory by observing and reporting the location of the load associated with each endpoint. In other embodiments, some or all of the endpoints may include transmission functionality to report back to the inventory process.

During a configuration process 96, the manner in which each wireless endpoint will respond to different demand response events is configured. Some example configuration techniques are shown in FIG. 5. Individual address functionality 98 enables each wireless endpoint to be manually configured to respond to a demand response event. For example, in some embodiments, all of the available endpoints may be displayed graphically on a computer screen. The building administrator can select or highlight each wireless endpoint that will respond to a specific demand response event. Alternatively, the designated endpoints may be added to a list or table associated with a demand response event.

Class configuration functionality 100 enables wireless endpoints to be configured based on a class or type of endpoint. For example, endpoints that control non-emergency lighting may be configured to turn off or reduce their loads in response to a certain level of demand signal, while endpoints that control computer equipment and emergency lighting remain fully on. The endpoints that control computer equipment may be further configured to turn off in response to a more restrictive type of demand response signal.

Zone configuration functionality 102 enables wireless endpoints to be configured by zones. For example, endpoints that control lighting in peripheral areas of a building with abundant ambient light may be configured to turn off or reduce their loads by a large amount in response to a demand response event, whereas endpoints that control lighting in inner areas of the building may keep their loads fully on or reduce them by a lesser amount.

Priority based configuration functionality 104 enables wireless endpoints to be configured based on priority levels of demand response events and/or their associated loads. For example, endpoints configured to control critical loads considered may only respond to high priority demand response events, whereas endpoints configured to control non-critical loads considered may only respond to low, medium and high priority demand response events.

Direct response configuration functionality 106 enables wireless endpoints to be configured to respond directly to a wireless demand response signal from a utility, a power plant, a power grid operator, etc.

Eavesdropping configuration functionality 107 enables the system to be configured by listening to wireless transmissions between components. For example, the system may be placed in a learning mode for a period of time. During the learning mode, if the system identifies communications from a wireless occupancy sensor, the system can configure itself to transmit a wireless demand signal that mimics the signal from the wireless occupancy sensor. Thus, the system may be configured to turn off any lights or other loads controlled by the wireless occupancy sensor in response to a demand response event.

The configuration process 96 may implement all, some, none and/or hybrids of any of the example configuration techniques shown in FIG. 5, as well as other configuration processes.

During an operation process 108, the system causes wireless demand signals to be sent to wireless demand response endpoints in accordance with the system configuration and in response to demand response events from various sources. Some operations may be controlled by automatic load shed functionality 110 in which a demand response event received from a utility, a power plant, a power grid operator, etc. is automatically processed and causes wireless demand signals to be transmitted. For example, a demand response signal from a utility may be interpreted to determine the seriousness of the request and assigned a priority. Based on the priority, a local demand signal may be transmitted only to specifically addressed endpoints, or broadcast to all endpoints which may then turn off or reduce their loads based on their configuration. As another example, a simple on/off demand response signal received from a utility may be rebroadcast to every endpoint, each of which handles the request according to its own configuration.

Some operations may be controlled by manual load shed functionality 112. For example, a work station or other hardware for a building administrator may be configured to provide a pop-up alarm when a demand response signal is received from a utility. The work station may then present the building administrator with a graphic display of all wireless endpoints which may be turned off by clicking on individual icons associated with each endpoint. Alternatively, the building administrator may respond by initiating one or more transmissions based on the individual address, classes, zones, priorities, etc. of the endpoints.

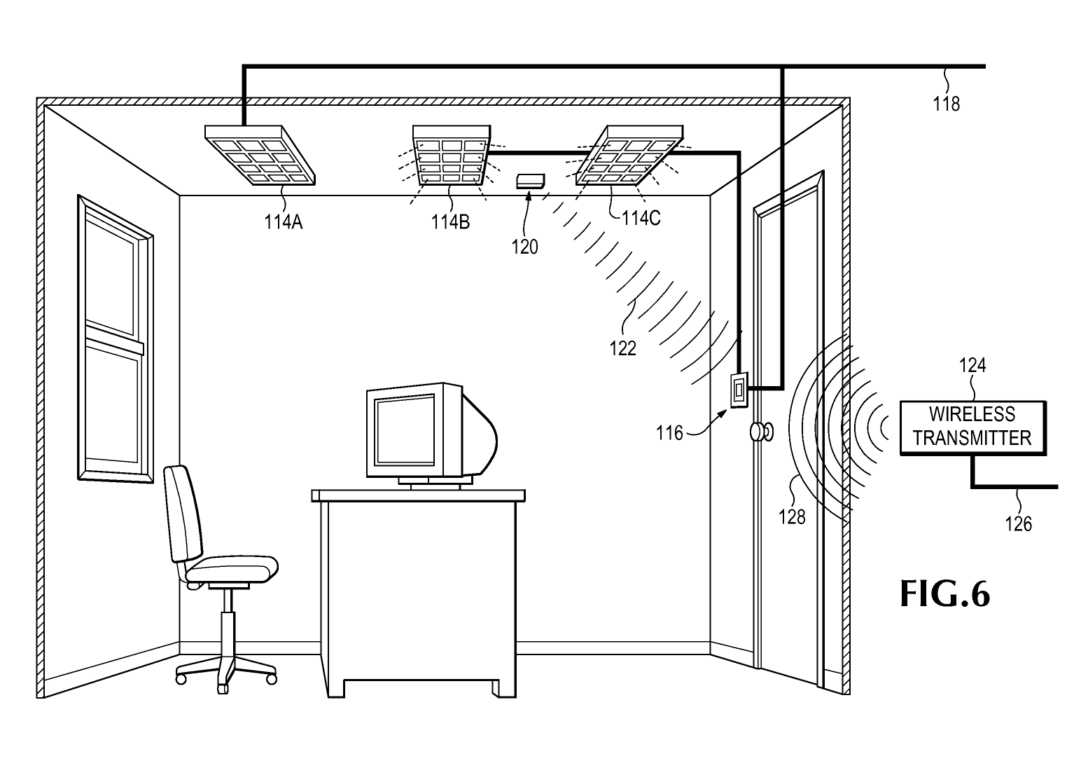

FIG. 6 illustrates an embodiment of a wireless demand response installation according to some inventive principles of this patent disclosure. A bank of light fixtures 114A-114C is fed by a branch circuit 118. One of the fixtures 114A is always on when the branch circuit is energized, but two of the fixtures 114B-114C are controlled by wall switch 116 that includes a wireless receiver. A wireless occupancy sensor 120 generates a wireless occupancy signal 122 in response to the presence or absence of occupants in the room. The wall switch 116 can control fixtures 114B-114C in response to both a manual actuator and the wireless occupancy signal.

A wireless demand response transmitter 124 is connected to a building management network 126 and is within transmission range and/or position of the wireless enabled wall switch 116. In response to a demand signal received over the network 126 from a utility, building administrator or other source, the wireless transmitter 124 transmits a wireless demand signal 128 to the wall switch 116. The wall switch 116 may respond to the wireless demand signal depending on the configuration of the wall switch, the wireless transmitter 124 and other system components. For example, the system may be configured so the wall switch 116 always turns off or dims lighting fixtures 114B-114C in response to the wireless demand signal and leaves them off or dimmed until the demand response event is over, regardless of any manual actuation of the wall switch by an occupant. Alternatively, the wall switch may turn off or dim lighting fixtures 114B-114C in response to the wireless demand signal, but then subsequently allow an occupant to manually operate the light fixtures even during the demand response event. As another alternative, the system may be configured so the occupants' ability to manually operate the lights depends on a priority level of the wireless demand signal.

The system illustrated in FIG. 6 may enable a wireless demand response system to be implemented using mostly off-the-shelf (stocked) components and/or with no or minimal modification to a building structure. The wireless occupancy sensor 120 and wireless enabled wall switch 116 may already be installed in a building or may be readily available, as well as easy, inexpensive, and quick to install. Thus, a wireless demand response endpoint may be implemented by simply adding the wireless transmitter and any accompanying support apparatus and software. In some embodiments, the wireless demand signal may be implemented to appear the same as the wireless occupancy signal 122, thereby eliminating the need for additional binding, configuration and/or programming, etc.

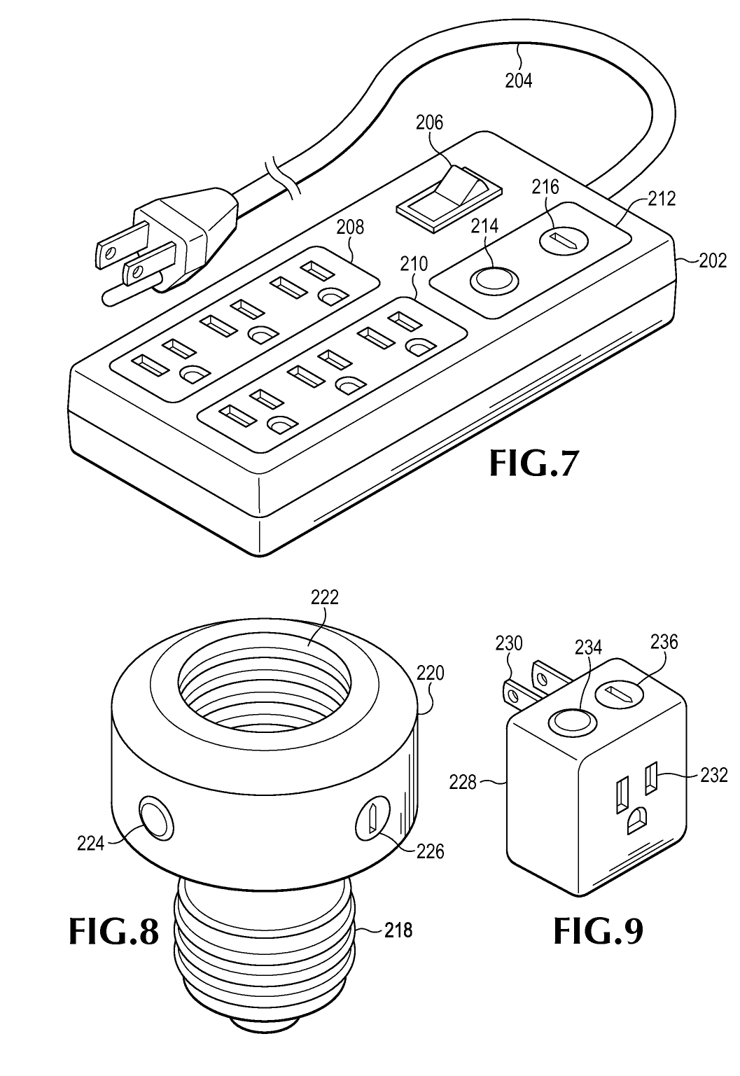

FIG. 7 illustrates an embodiment of a power strip for a wireless demand response system according to some inventive principles of this patent disclosure. The embodiment of FIG. 7 includes a housing 202 having a power cord 204 that can be plugged into a standard power receptacle. A first group of receptacles 208 is controlled only by a master switch 206. A second group of receptacles 210 is also controlled by the master switch, but may also be controlled by a power switching device 212 in response to a wireless demand signal. A wireless receiver 214 receives the wireless demand signal and controls the second group of receptacles 210 accordingly. In this embodiment, a user interface includes a selector switch 216 to enable a user to configure the power strip address, class, zone, priority or other configuration information, but other embodiments may include a dip switches, a keypad and display, any other type of user interface, either hidden or visible, or no user interface. To facilitate the orderly shutdown of a computer that may be plugged into the power strip, a communication interface may be included to transmit a message to the computer in advance of powering down to enable the computer to initiate its shutdown sequence.

FIG. 8 illustrates an embodiment of a lamp adapter for a wireless demand response system according to some inventive principles of this patent disclosure. A body 220 includes a screw base 218 that can be mounted in a screw-type lamp socket. A screw-in socket 222 enables an incandescent lamp, compact fluorescent lamp (CFL) or other load to be connected to the adapter. A switch in the body operates in response to a wireless demand signal received by a wireless receiver 224. A selector switch 226 enables a user to configure the lamp adapter with an address, class, zone, priority or other information.

FIG. 9 illustrates an embodiment of an in-line power module for a wireless demand response system according to some inventive principles of this patent disclosure. The module includes a body 228 having blades to form a power plug 230 extending from the back of the body to connect the device to a standard wall receptacle. A receptacle 232 is formed in the front of the body. A power switch inside the body controls the flow of power from the plug 230 to the receptacle 232 in response to a wireless demand signal received by a wireless receiver 234. A selector switch 236 enables a user to configure the power module with an address, class, zone, priority or other information.

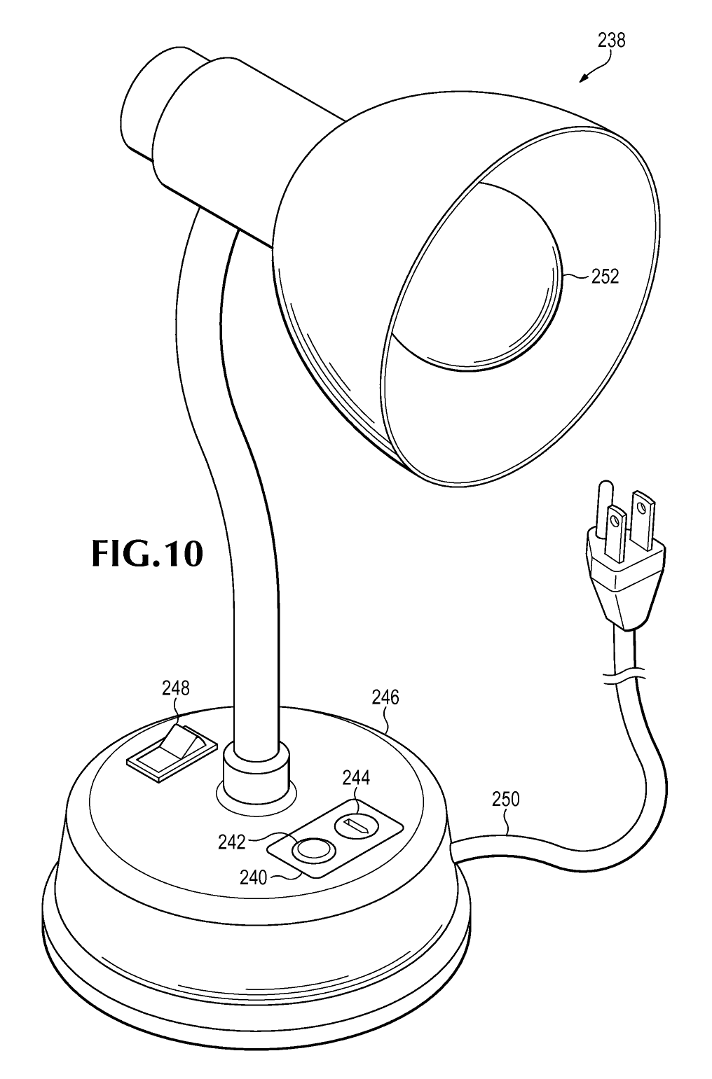

FIG. 10 illustrates an embodiment of an appliance for a wireless demand response system according to some inventive principles of this patent disclosure. In the embodiment of FIG. 10, a power switching device 240 is integrated directly into the appliance 238, which in this example is a task light, but could be any other suitable electrical appliance. The power switching device 240 is mounted in a base 246 of the task light which may be plugged in to a wall receptacle through a power cord 250. A power switch inside the power switching device controls the flow of power from the cord 250 to a lamp 252 in response to a wireless demand signal received by a wireless receiver 242. A selector switch 244 enables a user to configure the appliance with an address, class, zone, priority or other information. A master switch 248 may completely de-energize the entire appliance.

The embodiments of FIGS. 7-10 may be portable in the sense that they may be removed from an interior or exterior building space without disconnecting any permanent building wiring.

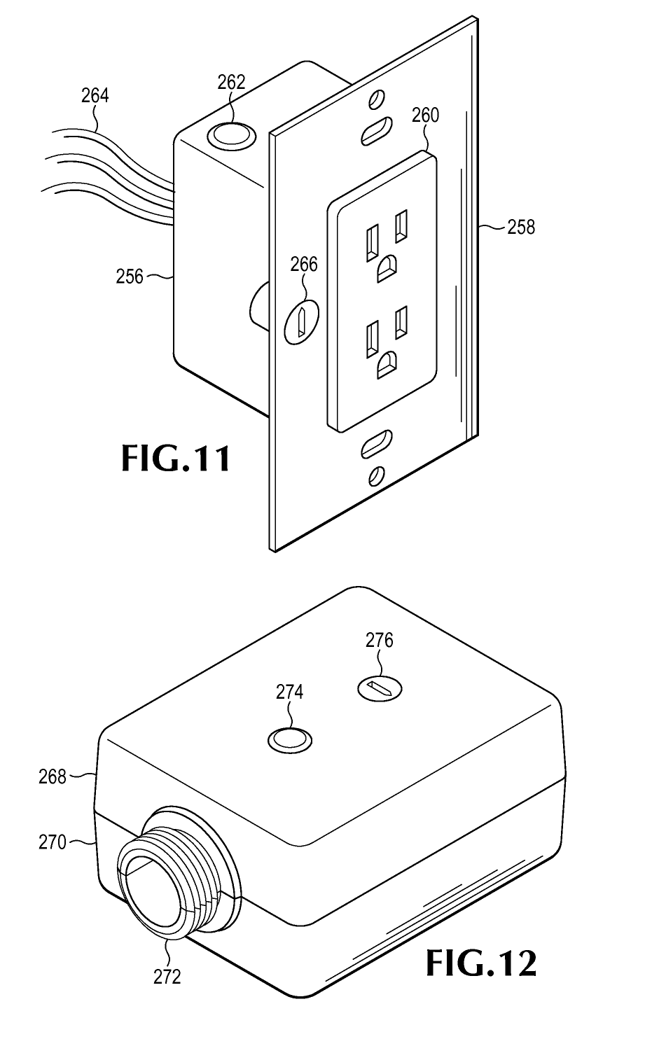

FIG. 11 illustrates an embodiment of an outlet for a wireless demand response system according to some inventive principles of this patent disclosure. The embodiment of FIG. 11 is configured as a wall outlet having a duplex receptacle 260. A mounting plate 258 enables the entire assembly to be mounted in a standard electrical wall box. A power switch may be enclosed in a housing 256. Power connections to the switch may be through pigtail wire leads 264, screw terminals, or other types of connections which may include hot, neutral, and ground connections for, e.g., a 120 VAC branch circuit.

The power switch inside the housing controls the flow of power from the wire leads to the duplex receptacle 260 in response to a wireless demand signal received by a wireless receiver 262. A selector switch 266 enables a user to configure the outlet with an address, class, zone, priority or other information. In this embodiment, the selector switch is located on the face mounting plate 258 so that it can be adjusted by removing the wall plate, but without having to remove the assembly from the wall box. In other embodiments, the dial or other user interface may be located directly on the receptacle, on or inside the housing, etc.

FIG. 12 illustrates an embodiment of a power pack for a demand response sensing system according to some inventive principles of this patent disclosure. The embodiment of FIG. 12 may be mounted directly to or in a light fixture, exhaust fan, space heater, or other electrical load. Alternatively, it may be mounted to or in an electrical box located anywhere on a branch circuit. The power pack includes an enclosure having two housing halves 268 and 270. A conduit connection 272 molded into the housing halves provides a mechanical connection to a load or electrical box. The power pack may include one or more power switches to control the flow of power to one or more loads. The switches may operate at relatively high voltages such as 120, 240 or 277 VAC as is commonly used in building wiring systems, although some embodiments may operate at other voltages such as 12 VDC, e.g., for landscape wiring. The power pack may also include a power supply to convert high-voltage power to a low-voltage source for operating the internal circuitry.

The power switches inside the housing control the flow of power to the loads in response to a wireless demand signal received by a wireless receiver 274. A selector switch 276 enables a user to configure the power pack with an address, class, zone, priority or other information.

The inventive principles of this patent disclosure have been described above with reference to some specific example embodiments, but these embodiments can be modified in arrangement and detail without departing from the inventive concepts. For example, some of the embodiments have been described in the context of lighting loads, but the inventive principles apply to other types of electrical loads as well. Any of the functionality described herein may be implemented in analog and/or digital hardware, software, firmware, etc., or any combination thereof. As another example, some of the embodiments have been described in the context of interior building spaces, but the inventive principles apply to exterior or hybrid spaces as well. Such changes and modifications are considered to fall within the scope of the following claims.

1. A method comprising:
receiving a wireless demand signal at an endpoint; and
controlling a power switch at the endpoint in response to the wireless demand signal.

2. The method of claim 1 where:
the endpoint is at a premises; and
the method further comprises transmitting the wireless demand signal at the premises.

3. The method of claim 2 where the wireless demand signal is transmitted in response to a demand signal received from outside the premises.

4. The method of claim 2 where the wireless demand signal is transmitted in response to an action by a person.

5. The method of claim 2 further comprising controlling the power switch at the endpoint in response to a wireless control signal.

6. The method of claim 5 where the wireless control signal comprises a wireless occupancy signal.

7. The method of claim 5 where the wireless demand signal and the wireless control signal appear the same at the endpoint.

8. The method of claim 2 where the wireless demand signal includes a demand response code that causes the power switch to respond to the wireless demand signal.

9. The method of claim 2 where the wireless demand signal includes a priority.

10. The method of claim 2 where the wireless demand signal includes an address that causes the power switch to respond to the wireless demand signal.

11. A system comprising:
an endpoint device having a power switch; and
a wireless receiver to control the power switch in response to a wireless demand signal.

12. The system of claim 11 where the endpoint device includes the wireless receiver.

13. The system of claim 11 where the endpoint device may be configured to learn to respond to the wireless demand signal.

14. The system of claim 11 where the endpoint device may be configured to respond to an address in the wireless demand signal.

15. The system of claim 11 where the endpoint device may be configured to respond to a demand response code in the wireless demand signal.

16. The system of claim 11 where the endpoint device may be configured to respond to a broadcast wireless demand signal.

17. The system of claim 11 where the endpoint device may be configured to respond to a priority in the wireless demand signal.

18. The system of claim 11 where the endpoint device comprises a wall switch.

19. The system of claim 11 where the endpoint device comprises a power pack.

20. The system of claim 11 where the endpoint device comprises an outlet.

21. The system of claim 20 where outlet comprises a receptacle.

22. The system of claim 11 where the endpoint device comprises a portable switching device.

23. A system comprising:
a building energy management system; and
a wireless transmitter coupled to the energy management system to transmit a wireless demand signal to one or more wireless endpoints at the building.

24. The system of claim 23 where the system may inventory the one or more wireless endpoints.

25. The system of claim 23 further comprising a user interface to configure the system.

26. The system of claim 25 where the user interface comprises a workstation.

27. The system of claim 25 where the user interface enables a user to configure the one or more wireless endpoints to respond to the wireless demand signal.

28. The system of claim 27 where the user interface enables the user to configure individual wireless endpoints to respond to the wireless demand signal.

29. The system of claim 23 further comprising a user interface to operate the system.

30. The system of claim 29 where the user interface enables the user to initiate a transmission of the wireless demand signal.

31. The system of claim 23 where the system may transmit the wireless demand signal in response to a demand response signal received from outside the system.

32. The system of claim 31 where the demand response signal received from outside the system is transmitted by a utility.

33. The system of claim 31 where the system may transmit the wireless demand signal automatically in response to the demand response signal received from outside the system.
